(19) United States
(12) Patent Application Publication
(10) Pub. No.: US 2012/0020740 A1
(43) Pub. Date: Jan. 26, 2012

(54) CONNECTION STRUCTURE FOR A MANHOLE PIPE AND A SEWER MAIN PIPE

(76) Inventor: Norio Otsuga, Toyama-ken (JP)

(21) Appl. No.: 12/840,924

(22) Filed: Jul. 21, 2010

(51) Int. Cl. F16L 55/18

(52) U.S. Cl. 405/184.2

(57) ABSTRACT

In a connection structure (A) for a manhole pipe (1) and sewer main pipe (2) in which the sewer main pipe (2) places one end at a circular opening (12) of the manhole pipe (1) through a flexible coupler (F), the flexible coupler (F) has a rubber coupler body (3). Around an inner surface of the rubber coupler body (3), there is provided a water-sealing ridge (32) with a butylene rubber layer (33) placed around an outer surface of the rubber coupler body (3). On a rear end surface of the rubber coupler body (3), has an outer flange (31) which is brought into engagement with an outer periphery of the circular opening (12) upon inserting the rubber coupler body (3) to the circular opening (12) of the manhole pipe (1). A rubber coupler cylinder (5) is provided to have a diameter-increased cylinder portion (51), a diameter-reduced cylinder portion (52) and a transitionary portion (53) connecting the diameter-increased cylinder portion (51) to the diameter-reduced cylinder portion (52). The diameter-increased cylinder portion (51) has one end firmly fit to an outer surface of one end of a rigid circular pipe (4). The diameter-reduced cylinder portion (52) has one end firmly fit to an outer surface of one end of the sewer main pipe (1).

### BACKGROUND OF THE INVENTION

1. Field of the Invention

The invention relates to a connection structure and connection method for connecting a manhole pipe to a sewer main pipe.

2. Description of Related Art

In a connection structure for connecting a manhole pipe to a sewer main pipe, the manhole pipe and the sewer main pipe are rigidly connected as disclosed by Japanese Laid-open Patent Application No. 11-241356. With the rigid connection structure thus disclosed, the manhole pipe and the sewer main pipe are individually shaken in different degrees when subjected to a vibration. This arises a possibility that the pipes are broken at their connection area when an earthquake happens since no means is provided to absorbe the tremor.

In order to avoid this situation, it is thought to provide a flexible connection between the manhole pipe and the sewer main pipe through a flexible coupler. This requires a large-scale expander machine upon securing a liquid-tightness between the flexible coupler and an outer side wall of the manhole pipe.

The ferro-concrete manhole pipe is normally circular in cross section, so that the large-scale expander machine is placed inside the inner wall of the manhole pipe, which narrows an interior space inside the manhole pipe, thus making it troublesome to work inside the manhole pipe so as to put the safety at risk.

Therefore, it is an object of the invention to provide a connection structure and connection method which is capable of rendering a connection work easy between a manhole pipe and a sewer main pipe, while at the same time, securing a high liquid-tightness therebetween.

### SUMMARY OF THE INVENTION

According to the invention, there is provided a connection structure for a manhole pipe and sewer main pipe in which the sewer main pipe places one end at a circular opening which is provided with a side wall of the manhole pipe so as to connect the sewer main pipe to the manhole pipe through a flexible coupler.

A cylindrical rubber coupler body has a water-sealing ridge around an inner surface of the rubber coupler body, and having a gluey rubber layer around an outer surface of the rubber coupler body. One end of the cylindrical rubber coupler body has an outer flange which is brought into engagement with an outer periphery of the circular opening upon inserting the cylindrical rubber coupler body to the circular opening of the manhole pipe.

A rigid circular pipe is press fit inside the cylindrical rubber coupler body by working outside the manhole pipe. A rubber coupler cylinder is provided to have a diameter-increased cylinder portion, a diameter-reduced cylinder portion and a transitionary portion connecting the diameter-increased cylinder portion to the diameter-reduced cylinder portion. The diameter-increased cylinder portion has one end firmly fit to an outer surface of one end of the rigid circular pipe which resides outside the manhole pipe. The diameter-reduced cylinder portion has one end firmly fit to an outer surface of one end of the sewer main pipe which resides outside the manhole pipe.

The connection work is done in following procedures.

The rubber coupler body is inserted to the circular opening at the side wall of the manhole pipe, while at the same time, bringing the outer flange into engagement with an outer periphery of the circular opening. Then, the rigid circular pipe is press fit into the rubber coupler body by working outside the manhole pipe.

To one end side of the rigid circular pipe which is located outside of the manhole, inserted is the diameter-increased cylinder portion of the rubber coupler cylinder to firmly fit the diameter-increased cylinder portion to the outer surface of the rigid circular pipe. The sewer main pipe is made positionally adjustable so that the sewer main pipe has its front end come on a level with the inner wall of the manhole pipe.

The diameter-reduced cylinder portion of the rubber coupler cylinder is inserted to the outer surface of the sewer main pipe which is located outside the manhole pipe.

The connection structure has following advantages.

With the gluey rubber layer provided around the outer surface of the rubber coupler body, the rubber coupler body diametrically expands outward to press the gluey rubber layer against an inner surface of the circular opening upon press fitting the rigid circular pipe into the rubber coupler body, thus securing the liquid-tightness between the outer surface of the rubber coupler body and the inner surface of the circular opening.

With the water-sealing ridge provided around the inner surface of the cylindrical rubber coupler body, the water-sealing ridge is pushed to diametrically distend the rubber coupler body outward upon fitting the rigid circular pipe into the rubber coupler body.

In this instance, the water-sealing ridge exerts its elastic force to engage itself with the rigid circular pipe. This enables a user to insure the liquid-tightness between the inner surface of the circular opening and the outer surface of the rubber coupler body (between the outer surface of the rigid circular pipe and the inner surface of the rubber coupler body), thus making it possible to liquid-tightly connect the rigid circular pipe to the circular opening of the manhole pipe.

To the outer surface of one end side of the rigid circular pipe, the diameter-increased cylinder portion is fixedly fit by working outside the manhole pipe, while at the same time, fixedly fitting the diameter-reduced cylinder portion to the outer surface of the sewer main pipe. This makes it possible to connect the rigid circular pipe to the sewer main pipe through the rubber coupler cylinder.

Through the flexible coupler (the rubber coupler cylinder, the rigid circular pipe and the rubber coupler body), it is possible to liquid-tightly connect the sewer main pipe to the circular opening of the manhole pipe.

Upon connecting the sewer main pipe to the manhole pipe, the rubber coupler body is inserted into the circular opening due to the work outside the manhole pipe, and the rigid circular pipe is press fit into the rubber coupler body by working outside the manhole pipe. Then, the diameter-increased cylinder portion is fixedly fit into the outer surface of one end side of the rigid circular pipe, while at the same time, fixedly fitting the diameter-reduced cylinder portion into the outer surface of the sewer main pipe by working outside the manhole pipe. This makes it possible to easily connect the sewer main pipe to the circular opening of the manhole pipe for a short period of time.

According to other aspect of the invention, each of the rigid circular pipe and the sewer main pipe has one open end surface arcuately skived to have a radius of curvature identical to a radius of curvature of an inner wall of the manhole pipe.

This makes it possible to avoid one open end surfaces of both the rigid circular pipe and the sewer main pipe from extending into the interior space of the manhole pipe, thereby preventing the interior space of the manhole pipe from being narrowed, thus enabling the user to render the connecting work easy so as to insure the safety.

According to other aspect of the invention, the water-sealing ridge has a front end inclined in a direction from an outside to inside of the manhole pipe by an angle ranging from 15 to 60 degrees against the inner surface of the rubber coupler body so as to accept the rigid circular pipe as an entrance article upon inserting the rigid circular pipe into the rubber coupler body.

This makes it possible to readily insert the rigid circular pipe into the rubber coupler body so as to make the connection work complete for a short period of time.

According to other aspect of the invention, the sewer main pipe is made of synthetics or a metallic steel, and the sewer main pipe places one end at a circular opening which pierces through a side wall of the manhole pipe so as to connect the sewer main pipe to the manhole pipe through a rubber-based coupler. The rubber-based coupler has a gluey rubber layer circumferentially around an outer surface of the rubber-based coupler, and having a water-sealing ridge around an inner surface of the rubber-based coupler. At one end surface of the rubber-based coupler, an outer flange is provided which is brought into engagement with an outer periphery of the circular opening upon inserting the rubber-based coupler to the circular opening of the manhole pipe.

The connection work is done as follows:

The rubber-based coupler is inserted into the circular opening by working outside the manhole pipe, while at the same time, bringing the outer flange into engagement with an outer periphery of the circular opening. Then, the sewer main pipe is press fit into the rubber-based coupler outside the manhole pipe.

Following advantages are obtained.

With the gluey rubber layer provided circumferentially around the outer surface of the rubber-based coupler, the sewer main pipe diametrically distends the rubber-based coupler to press the gluey rubber layer against the inner surface of the circular opening upon fitting the sewer main pipe into the rubber-based coupler, thus maintaining the liquid-tightness between the rubber-based coupler and the inner surface of the circular opening. In this way, the sewer main pipe is liquid-tightly connected to the circular opening of the manhole pipe through the rubber-based coupler when the sewer main pipe is made of the synthetics or metallic steel.

Due to the water-sealing ridge provided around the inner surface of the rubber-based coupler, upon fitting the sewer main pipe into the rubber-based coupler, the sewer main pipe elastically pushes the water-sealing ridge outward to exert the rubber-based coupler to diametrically expand the rubber-based coupler, while at the same time, bringing the water-sealing ridge into elastical engagement with an outer surface of the sewer main pipe.

This makes it possible to concurrently insure the liquid-tightness between the inner surface of the circular opening and the outer surface of the rubber-based coupler (between the outer surface of the sewer main pipe and the inner surface of the rubber-based coupler), thus enabling the user to liquid-tightly connect the sewer main pipe to the circular opening of the manhole pipe through the rubber-based coupler.

Upon connecting the sewer main pipe to the manhole pipe, the rubber-based coupler is interfit into the circular opening by working outside the manhole pipe, while at the same time, inserting the sewer main pipe into the rubber-based coupler. This leads to easily connecting the sewer main pipe to the circular opening of the manhole pipe for a short period of time.

According to other aspect of the invention, a circular opening is provided which pierces through a side wall of the manhole pipe, and a cylindrical rubber coupler body is provided to have a gluey rubber layer circumferentially around an outer surface of the rubber coupler body. Around an inner surface of the rubber coupler body, a water-sealing ridge is provided and an outer flange is provided at a rear end surface of the rubber coupler body.

The sewer main pipe is connected to the manhole pipe in following procedures.

The rubber coupler body is inserted to the circular opening by working outside the manhole pipe, in such a fashion that the outer flange is brought into engagement with the outer periphery of the circular opening (fitting step).

The rigid circular pipe is press fit into the rubber coupler body by working outside the manhole pipe (press fitting step).

The rubber coupler cylinder is set to have the diameter-increased cylinder portion, the diameter-reduced cylinder portion and the transitionary portion connecting the diameter-increased cylinder portion to the diameter-reduced cylinder portion (setting step).

One end portion of the diameter-increased cylinder portion is firmly fit to the outer surface of one end of the rigid circular pipe which resides outside the manhole pipe (firmly fitting step).

One end portion of the diameter-reduced cylinder portion is firmly fit to the outer surface of one end of the sewer main pipe which resides outside the manhole pipe, so as to be on a level with an inner wall of the manhole pipe upon inserting a front end of the sewer main pipe to the rubber coupler cylinder by working outside the manhole pipe (firmly interfitting step).

With the gluey rubber layer provided circumferentially around the outer surface of the rubber coupler body, the rigid circular pipe diametrically distends the rubber coupler body to press the gluey rubber layer against the inner surface of the circular opening upon fitting the rigid circular pipe into the rubber coupler body, thus maintaining the liquid-tightness between the rubber coupler body and the inner surface of the circular opening.

Due to the water-sealing ridge provided around the inner surface of the rubber coupler body, upon fitting the rigid circular pipe into the rubber coupler body, the rigid circular pipe elastically pushes the water-sealing ridge outward to exert the rubber coupler body to diametrically expand, while at the same time, bringing the water-sealing ridge into elastical engagement with the outer surface of the sewer main pipe.

This makes it possible to concurrently insure the liquid-tightness between the inner surface of the circular opening and the outer surface of the rubber coupler body (between the outer surface of the rigid circular pipe and the inner surface of the rubber coupler body), thus enabling the user to liquid-tightly connect the rigid circular pipe to the circular opening of the manhole pipe through the rubber coupler body.

Upon connecting the sewer main pipe to the rigid circular pipe, the diameter-increased cylinder portion is fit to an outer surface of one end side of the rigid circular pipe which resides outside the manhole pipe, while at the same time, fitting the diameter-reduced cylinder portion to an outer surface of the sewer main pipe which resides outside the manhole pipe. In this way, the sewer main pipe is liquid-tightly connected to the circular opening of the manhole pipe through the flexible coupler (including the rubber coupler cylinder, the rubber coupler body and the rigid circular pipe).

The rubber coupler body is inserted into the circular opening by working outside the manhole pipe, while at the same time, fitting the rigid circular pipe to the rubber coupler body outside the manhole. After fitting the rubber coupler cylinder into one end side of the rigid circular pipe, the diameter-increased cylinder portion is fit to the outer surface of one end side of the rigid circular pipe.

After inserting the sewer main pipe to the rubber coupler cylinder, the diameter-reduced cylinder portion is fit to the outer surface of the sewer main pipe. This leads to easily connecting the sewer main pipe to the circular opening of the manhole pipe for a short period of time.

According to other aspect of the invention, a circular opening is provided which pierces through a side wall of the manhole pipe, and a cylindrical rubber-based coupler is provided to have a gluey rubber layer circumferentially around an outer surface of the rubber-based coupler. Around an inner surface of the rubber-based coupler, a water-sealing ridge is provided on an inner surface of the rubber-based coupler, while at the same time, an outer flange is provided around a rear end surface of the rubber-based coupler.

The sewer main pipe is connected to the manhole in following procedures.

The rubber-based coupler is inserted to the circular opening by working outside the manhole pipe, in such a fashion that the outer flange is brought into engagement with an outer periphery of the circular opening (inserting step).

Then, the sewer main pipe is press fit into the rubber-based coupler by working outside the manhole pipe, in such a fashion that a front end of the sewer main pipe comes on a level with an inner wall of the manhole pipe (press fitting step).

With the gluey rubber layer provided circumferentially around the outer surface of the rubber-based coupler, the sewer main pipe diametrically distends the rubber-based coupler to press the gluey rubber layer against the inner surface of the circular opening upon fitting the sewer main pipe into the rubber-based coupler, thus maintaining the liquid-tightness between the rubber-based coupler and the inner surface of the circular opening.

Due to the water-sealing ridge, upon fitting the sewer main pipe into the rubber-based coupler, the sewer main pipe elastically pushes the water-sealing ridge outward to exert the rubber-based coupler to diametrically expand.

This makes it possible to concurrently insure the liquid-tightness between the inner surface of the circular opening and the outer surface of the rubber-based coupler (between the outer surface of the sewer main pipe and the inner surface of the rubber-based coupler), thus enabling the user to liquid-tightly connect the sewer main pipe to the circular opening of the manhole pipe through the rubber-based coupler.

Upon connecting the sewer main pipe to the manhole pipe, the rubber-based coupler is fit into the inner surface of the circular opening by working outside the manhole pipe, while at the same time, inserting the sewer main pipe into the rubber-based coupler.

This leads to easily connecting the sewer main pipe to the circular opening of the manhole pipe for a short period of time.

According to other aspect of the invention, a circular opening is provided which pierces through a side wall of the manhole pipe, and a cylindrical rubber coupler is provided to have a gluey rubber layer circumferentially around an outer surface of the rubber-based coupler. Around an inner surface of the rubber-based coupler, a water-sealing ridge is provided, while at the same time, an outer flange is provided at a rear end surface of the rubber coupler.

The rubber coupler is inserted to the circular opening by working outside the manhole pipe, in such a fashion that the outer flange is brought into engagement with an outer periphery of the circular opening of the manhole pipe (inserting step).

A cylindrical spacer is provided, an outer diameter of which is somewhat greater than an inner diameter of the rubber coupler. An engagement flange is provided at a rear end surface of the spacer, and the spacer is driven into the rubber coupler by working outside of the manhole pipe (driving step).

In this situation, the rubber coupler is diametrically distended to elastically engage with the inner surface of the circular opening of the manhole pipe.

The sewer main pipe is provided from synthetics or a metallic steel, and the sewer main pipe is press fit into the rubber coupler into which the spacer was driven, in such a fashion that a front end of the sewer main pipe comes on a level with an inner wall of the manhole pipe (press fitting step).

Due to the water-sealing ridge, upon fitting the sewer main pipe into the rubber coupler, the sewer main pipe elastically pushes the water-sealing ridge outward to exert the rubber coupler to diametrically expand.

This makes it possible to concurrently insure the liquid-tightness between the inner surface of the circular opening and the outer surface of the rubber coupler (between the outer surface of the sewer main pipe and the inner surface of the rubber coupler), thus enabling the user to liquid-tightly connect the sewer main pipe to the circular opening of the manhole pipe through the rubber coupler.

Upon connecting the sewer main pipe to the manhole pipe, the rubber coupler is fit into the inner surface of the circular opening by working outside the manhole pipe, while at the same time, driving the spacer into the rubber coupler outside of the manhole pipe before press fitting the sewer main pipe into the rubber coupler.

This leads to easily connecting the sewer main pipe to the circular opening of the manhole pipe for a short period of time.

### BRIEF DESCRIPTION OF THE DRAWINGS

Preferred forms of the present invention are illustrated in the accompanying drawings in which:

FIG. 1 is a longitudinal cross sectional view showing a manner when inserting a rubber coupler body to an inner surface of a circular opening by working outside a manhole pipe according to a first embodiment of the invention;

FIG. 2 is a longitudinal cross sectional view showing a manner when the rubber coupler body is inserted to the inner surface of the circular opening of the manhole pipe;

FIG. 3 is a longitudinal cross sectional view of the rubber coupler body;

FIG. 4 is a longitudinal cross sectional view of the circular opening of the manhole pipe;

FIG. 5 is a longitudinal cross sectional view showing a manner when press fitting a rigid circular pipe into the rubber coupler body with the use of a press-fitting apparatus;

FIG. 6 is a longitudinal cross sectional view showing a manner when the rigid circular pipe is press fit into the rubber coupler body;

FIG. 7 is a longitudinal cross sectional view showing a manner when inserting the sewer main pipe to a rubber coupler cylinder after fitting a diameter-increased cylinder portion to an outer surface of one end side of the rigid circular pipe;

FIG. 8 is a latitudinal cross sectional view showing a connection structure between the manhole pipe and the sewer main pipe;

FIG. 9 is a longitudinal cross sectional view showing the connection structure between the manhole pipe and the sewer main pipe;

FIG. 10 is a longitudinal cross sectional view showing a manner when inserting a rubber-based coupler to the inner surface of the circular opening by working outside the manhole pipe according to a second embodiment of the invention;

FIG. 11 is a longitudinal cross sectional view showing a manner when the sewer main pipe is press fit into the rubber-based coupler;

FIG. 12 is a longitudinal cross sectional view showing a manner when inserting a rubber coupler to the inner surface of the circular opening by working outside the manhole pipe, and a spacer is driven into the rubber coupler according to a third embodiment of the invention;

FIG. 13 is a longitudinal cross sectional view showing a manner when inserting the sewer main pipe into the rubber coupler, into which the spacer was driven outside of the manhole pipe; and

FIG. 14 is a longitudinal cross sectional view showing a connection structure between the sewer main pipe and the manhole pipe.

### DETAILED DESCRIPTION OF THE PREFERRED EMBODIMENTS

In the following description of the depicted embodiments, the same reference numerals are used for features of the same type.

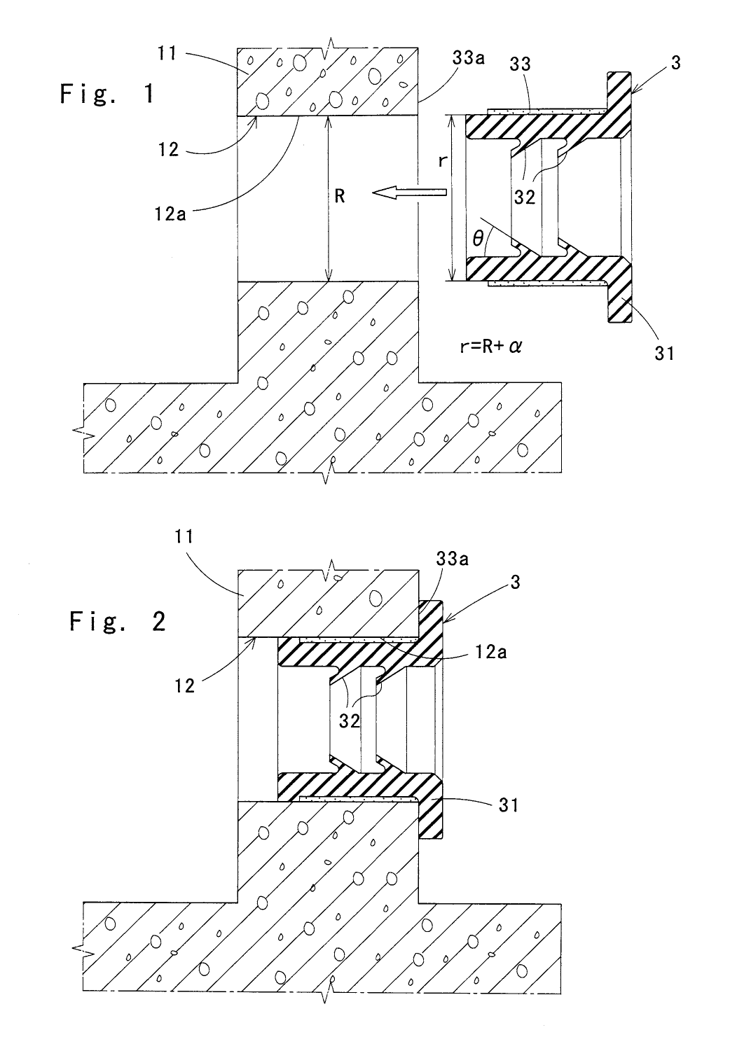

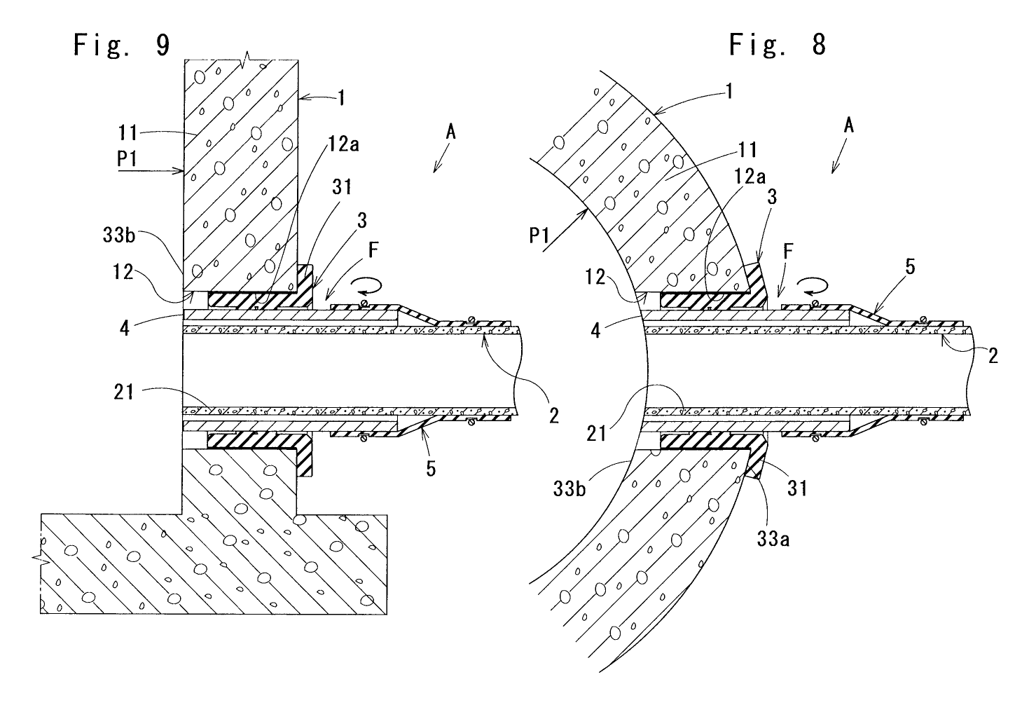

Referring to FIGS. 1 through 9 which show a connection structure (A) for a manhole pipe 1 and a sewer main pipe 2 according to a first embodiment of the invention, one end portion 21 of the sewer main pipe 2 is placed at a circular opening 12 which is provided in a fashion to pierce through a side wall 11 of the manhole pipe 1. The sewer main pipe 2 and the manhole pipe 1 (ferro-concrete pipe or concrete Hume pipe) are to be connected through a flexible coupler (F) as shown in FIGS. 8, 9.

The flexible coupler (F) has a cylindrical rubber coupler body 3, the rigid circular pipe 4 and the rubber coupler cylinder 5. The rubber coupler body 3 is to be fit into the circular opening 12 as best observed in FIGS. 1, 2. With a rear end surface of the rubber coupler body 3, an outer flange 31 is provided which is brought into engagement with an outer periphery of the circular opening 12 of the manhole pipe 1 upon fitting the rubber coupler body 3 into the circular opening 12.

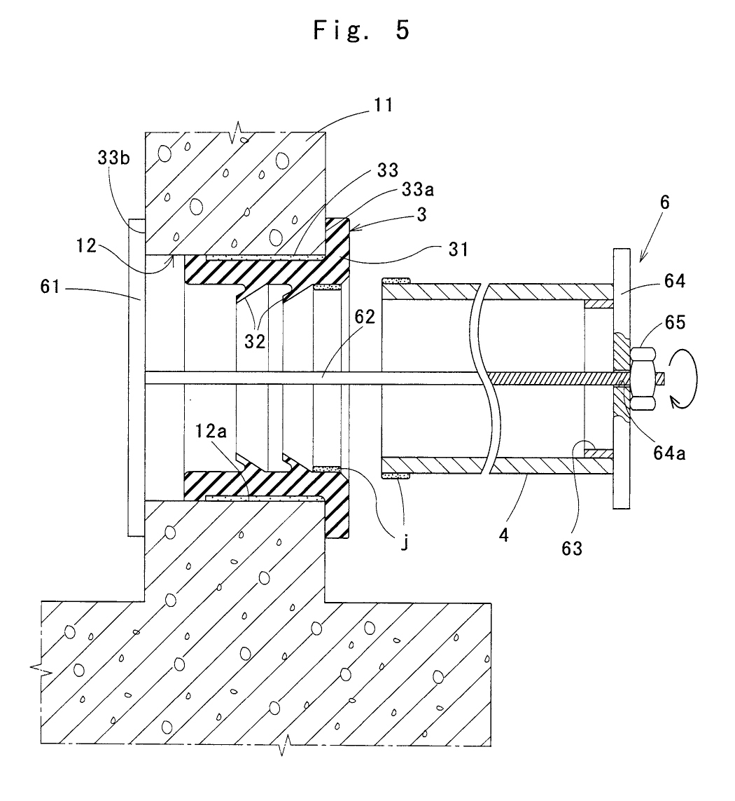

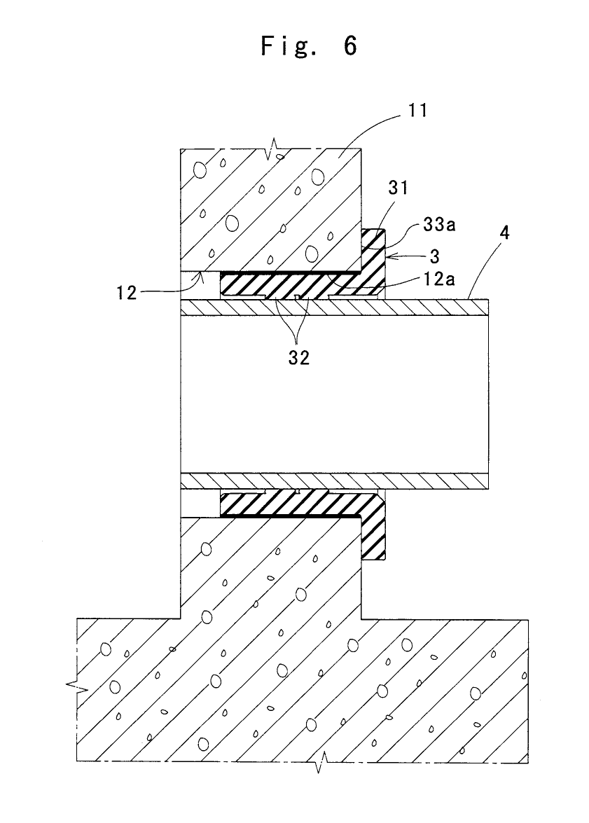

The rigid circular pipe 4 is to be interfit into the rubber coupler body 3 as shown in FIGS. 5, 6. The rubber coupler cylinder 5 is fit to an outer surface of the rigid circular pipe 4 and an outer surface of the sewer main pipe 2 at a portion in which the sewer main pipe 2 and the rigid circular pipe 4 are connected.

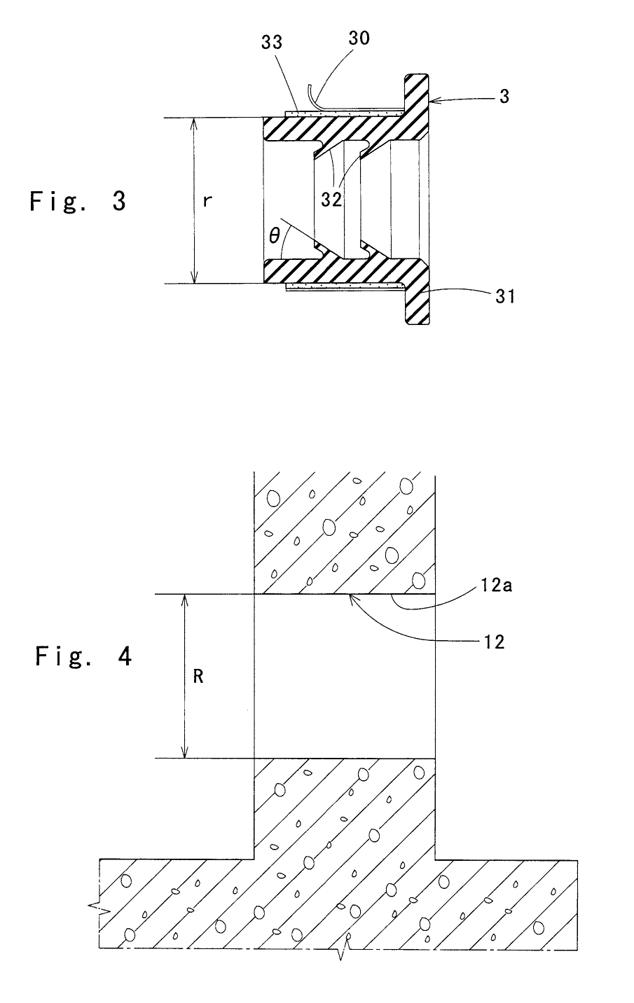

In integral with an inner surface of the rubber coupler body 3, two water-sealing ridges 32 are circumferentially provided in front and in rear as clearly shown in FIGS. 1, 3. Each of the water-sealing ridges 32 has a front end inclined in a direction from an outside to inside of the manhole pipe 1 by a predetermined angle (θ: e.g., 15-60 deg.) against the inner surface of the rubber coupler body 3 so as to accept the rigid circular pipe 4 as an entrance article upon inserting the rigid circular pipe 4 into the rubber coupler body 3.

With the outer surface of the rubber coupler body 3, a butylene rubber layer 33 (gluey rubber layer) is circumferentially provided, an outer surface of which is covered by a separable sheet 30. It is to be noted that the number of the water-sealing ridges 32 is not confined to two but three, four or five water-sealing ridges may be provided as a plural entity.

In order to secure the liquid-tightness between the rubber coupler body 3 and the circular opening 12, it is necessary to arrange that an outer diameter (r) of the rubber coupler body 3 is slightly greater by e.g., several millimeters (a) than an inner diameter (R) of the circular opening 12 of the manhole pipe 1 (r=R+α) as shown in FIGS. 3, 4. Since the rubber coupler body 3 is elastically deformable, it is possible to fit the rubber coupler body 3 into the circular opening 12 even when the rubber coupler body 3 is slightly greater diametrically than the circular opening 12.

As shown in FIG. 5, the rigid circular pipe 4 is made of a metallic steel, and is interfit into the rubber coupler body 3 with the use of a press-fitting apparatus 6 by working outside the manhole pipe 1. Upon interfitting the rigid circular pipe 4 into the rubber coupler body 3, the rigid circular pipe 4 pushes the water-sealing ridges 32 forward to elastically deform the water-sealing ridges 32 to exert its elastic force against an outer surface of the rigid circular pipe 4 so as to strongly engage the rubber coupler body 3 with the rigid circular pipe 4.

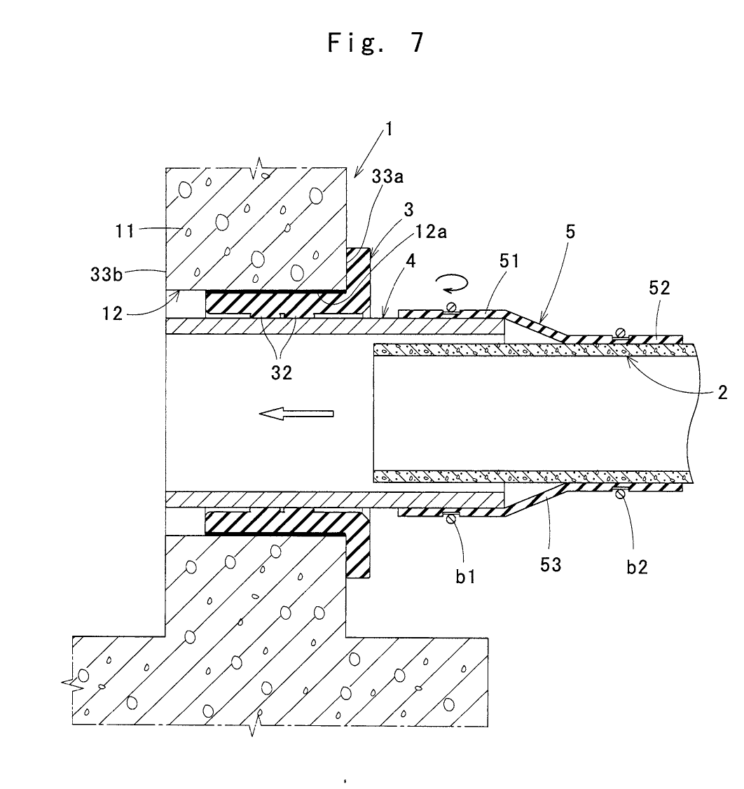

As shown in FIG. 7, a rubber coupler cylinder 5 has a diameter-increased cylinder portion 51, a diameter-reduced cylinder portion 52 and a transitionary portion 53 which connects the diameter-increased cylinder portion 51 to the diameter-reduced cylinder portion 52. The diameter-increased cylinder portion 51 has one end firmly fit to the outer surface of one end of the rigid circular pipe 4 which resides outside of the manhole pipe 1. With the use of a band metal (b2), the diameter-reduced cylinder portion 52 has one end firmly interfit to an outer surface of one end of the sewer main pipe 2 which resides outside of the manhole pipe 1.

In this instance, each of the rigid circular pipe 4 and the sewer main pipe 2 has one open end surface arcuately skived to have a radius of curvature identical to a radius (P1) of curvature of an inner wall 33b of the manhole pipe 1 as shown in FIGS. 8, 9.

In the connection structure (A), a connection work is done in following procedures.

(a) The circular opening 12 is drilled at the side wall 11 of the manhole pipe 1 as shown in FIG. 1.
(b) After taking the separable sheet 30 off the butylene rubber layer 33 as shown in FIG. 3, the rubber coupler body 3 is manually fit into the circular opening 12 by working outside the manhole pipe 1, while at the same time, bringing the outer flange 31 into engagement with an outer periphery 33a of the circular opening 12 as best observed in FIG. 2.
(c) A lubricant is applied to an inner surface of the rubber coupler body 3 and an outer surface of the rigid circular pipe 4 as shown by a denotation (j) in FIG. 5. With the use of the press-fitting apparatus 6, the rigid circular pipe 4 is press fit into the rubber coupler body 3 outside the manhole pipe 1 as shown in FIGS. 5, 6.
(d) The press-fitting apparatus 6 has a diameter-increased plate 61, an elongate screw bolt 62 and a diameter-reduced plate 64. The diameter-increased plate 61 is brought into engagement with an inner wall 33b of the manhole pipe 1. The diameter-reduced plate 64 is placed outside the manhole pipe 1 in registration with the diameter-increased plate 61.

The elongate screw bolt 62 passes axially through the rigid circular pipe 4, and having a front end welded to a central portion of the diameter-increased plate 61, while at the same time, having a rear end extended through a central hole 64a which is provided with the diameter-reduced plate 64. To the rear end of the screw bolt 62 which extends beyond the central hole 64a, a nut 65 is secured to be tightened. To an inner side of the diameter-reduced plate 64, a cylindrical guide 63 is secured which is to be inserted into the rigid circular pipe 4. By turning the nut 65 along the screw bolt 62, the nut 65 pushes the diameter-reduced plate 64 so that the rigid circular pipe 4 moves to interfit into the rubber coupler body 3.

(e) As shown in FIG. 7, the diameter-increased cylinder portion 51 of the rubber coupler cylinder 5 is inserted to an outer surface of one end side of the rigid circular pipe 4 which is located at the outside of the manhole. This firmly fit the diameter-increased cylinder portion 51 to the outer surface of the rigid circular pipe 4. As shown in FIGS. 8, 9, the sewer main pipe 1 is adjustably advanced so that its front end comes on a level with the inner wall 33b of the manhole pipe 1.

The diameter-reduced cylinder portion 52 of the rubber coupler cylinder 5 is inserted to the outer surface of the sewer main pipe 2 which is located outside the manhole pipe 1.

The connection structure (A) thus far described has following advantages.

With the butylene rubber layer 33 provided around the outer surface of the rubber coupler body 3, the rubber coupler body 3 diametrically expands outward to press the butylene rubber layer 33 against the inner surface 12a of the circular opening 12 upon press fitting the rigid circular pipe 4 into the rubber coupler body 3, thus securing the liquid-tightness between the outer surface of the rubber coupler body 3 and the inner surface 12a of the circular opening 12.

With the water-sealing ridges 32 provided around the inner surface of the cylindrical rubber coupler body 3, the water-sealing ridges 32 are pushed to diametrically distend the rubber coupler body 3 outward upon fitting the rigid circular pipe 4 into the rubber coupler body 3.

In this instance, the water-sealing ridges 32 exerts its elastic force to engage itself with an outer surface of the rigid circular pipe 4. This enables a user to insure the liquid-tightness between the inner surface 12a of the circular opening 12 and the outer surface of the rubber coupler body 3 (between the outer surface of the rigid circular pipe 4 and the inner surface of the rubber coupler body 3), thus making it possible to liquid-tightly connect the rigid circular pipe 4 to the circular opening 12 of the manhole pipe 1.

To the outer surface of one end side of the rigid circular pipe 4, the diameter-increased cylinder portion 51 is fixedly fit by working outside the manhole pipe 1, while at the same time, fixedly fitting the diameter-reduced cylinder portion 52 into the outer surface of the sewer main pipe 2 by working outside the manhole pipe 1. This makes it possible to liquid-tightly connect the rigid circular pipe 4 to the sewer main pipe 2 through the rubber coupler cylinder 5.

With the flexible coupler F having the rubber coupler cylinder 5, the rigid circular pipe 4 and the rubber coupler body 3, it is possible to liquid-tightly connect the sewer main pipe 2 to the circular opening 12 of the manhole pipe 1.

Upon connecting the sewer main pipe 2 to the manhole pipe 1, the rubber coupler body 3 is inserted into the circular opening 12 by working outside the manhole pipe 1, and the rigid circular pipe 4 is press fit into the rubber coupler body 3 outside the manhole pipe 1. Then, the diameter-increased cylinder portion 51 is fixedly fit to the outer surface of one end side of the rigid circular pipe 4 by working outside the manhole pipe 1, while at the same time, fixedly fitting the diameter-reduced cylinder portion 52 to the outer surface of the sewer main pipe 2 by working outside the manhole pipe 1. This makes it possible to easily connect the sewer main pipe 2 to the circular opening 12 of the manhole pipe 1 for a short period of time.

Each of the rigid circular pipe 4 and the sewer main pipe 2 has one open end surface which has the radius of curvature identical to the radius (P1) of curvature of an inner wall 33b of the manhole pipe 1. This makes it possible to avoid one open end surface of both the rigid circular pipe 4 and the sewer main pipe 2 from extending into the interior space of the manhole pipe 1, thereby preventing the interior space of the manhole pipe 1 from being narrowed, thus enabling the user to render the connecting work easy with safety.

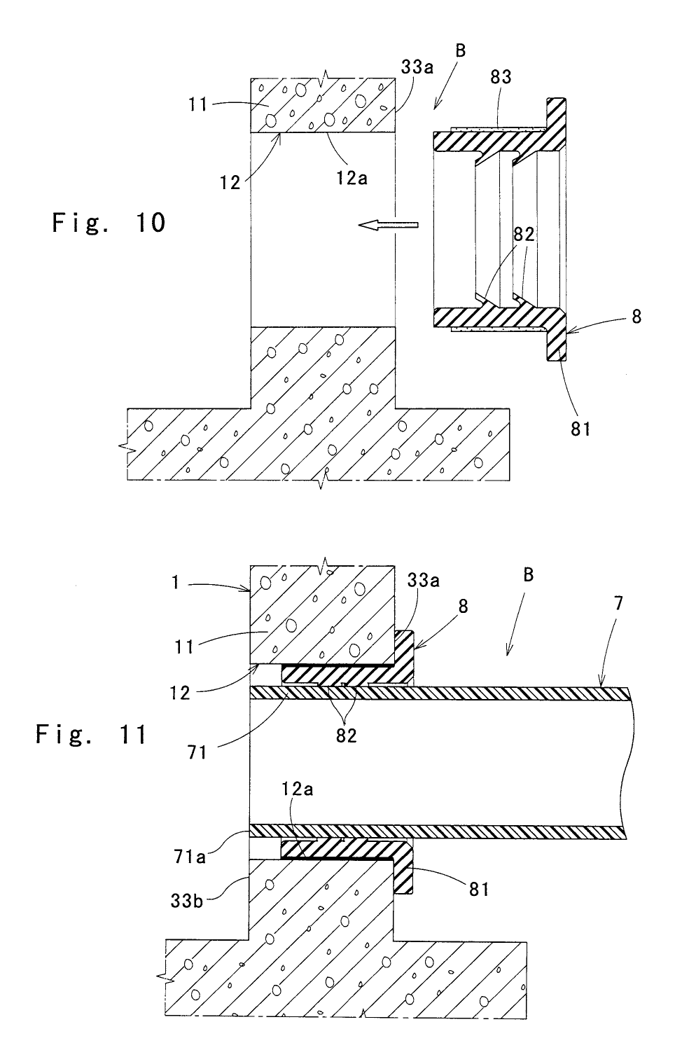

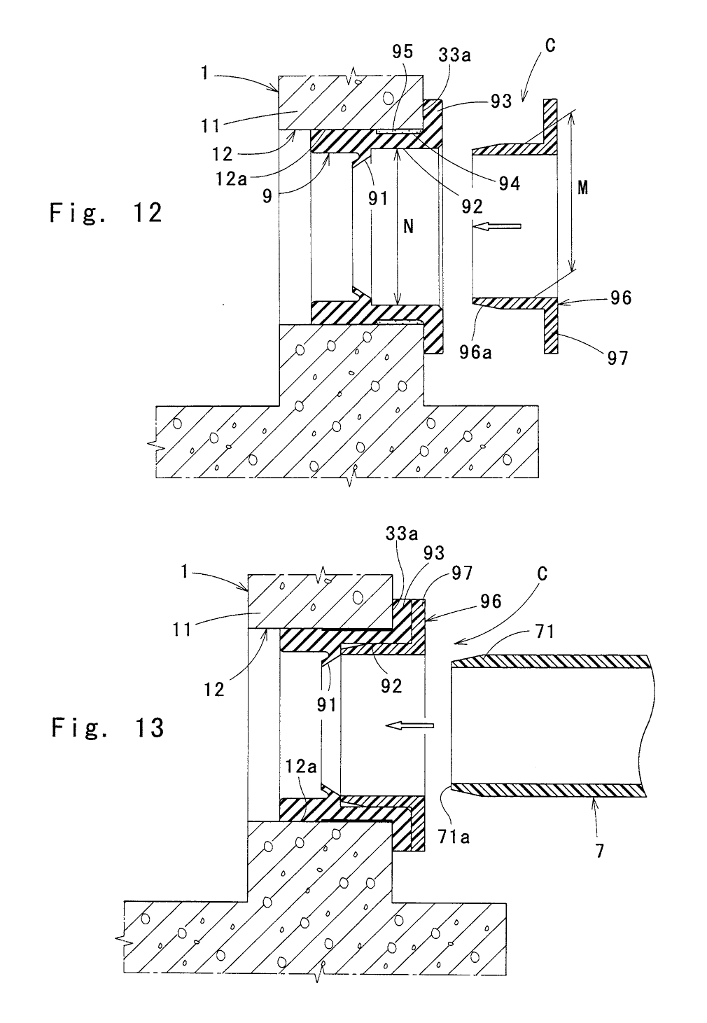

FIGS. 10, 11 show a second embodiment of the invention in which a rubber-based coupler 8 is used to accept a sewer main pipe 7 as the entrance article in a connection structure (B). At a rear end surface of the rubber-based coupler 8, an outer flange 81 is provided, and water-sealing ridges 82 are provided at the inner surface of the rubber-based coupler 8 as shown in FIG. 10.

At an outer surface of the rubber-based coupler 8, a butylene rubber layer 83 is provided, an outer surface of which is covered by a separable sheet (not shown).

The sewer main pipe 7, which is made of synthetics (e.g., vinyl chloride resin), has a front end 71 which corresponds to the circular opening 12 of the manhole pipe 1. It is to be noted that the sewer main pipe 7 may be made of a metallic steel as in the case of the first embodiment of the invention.

In the connection structure (B), the connection work is done in following procedures.

(a) After drilling the circular opening 12 at the side wall 11 of the manhole pipe 1, the rubber-based coupler 8 is manually brought to fit into the circular opening 12 with the separable sheet removed from the rubber-based coupler 8 as shown in FIG. 10.
(b) After fitting the rubber-based coupler 8 into the circular opening 12 with the outer flange 81 engaged against the outer periphery 33a of the circular opening 12 as shown in FIG. 11.
(c) The sewer main pipe 7 is adjustably moved by inching in front and in rear with a work outside the manhole pipe 1, so that the sewer main pipe 7 has its front end 71a come on a level with the inner wall 33b of the manhole pipe 1 as shown in FIG. 11.

Upon interfitting the sewer main pipe 7 into the rubber-based coupler 8, the sewer main pipe 7 pushes the water-sealing ridges 82 forward to elastically deform the water-sealing ridges 82 to exert its elastic force against an outer surface of the sewer main pipe 7 so as to strongly engage the rubber-based coupler 8 with the sewer main pipe 7.

The connection structure (B) has following advantages.

Upon connecting the sewer main pipe 7 to the manhole pipe 1, the rubber-based coupler 8 is inserted into the circular opening 12 by working outside the manhole pipe 1, while at the same time, inserting the sewer main pipe 7 into the rubber-based coupler 8 when the sewer main pipe 7 is made of the synthetics or metallic steel. This leads to easily connecting the sewer main pipe 7 to the circular opening 12 of the manhole pipe 1 for a short period of time.

With the butylene rubber layer 83 provided around the rubber-based coupler 8, the sewer main pipe 7 diametrically distends the rubber-based coupler 8 to press the butylene rubber layer 83 against the inner surface of the circular opening 12 upon fitting the sewer main pipe 7 into the rubber-based coupler 8, thus maintaining the liquid-tightness between the outer surface the rubber-based coupler 8 and the inner surface of the circular opening 12. In this way, the sewer main pipe 7 is liquid-tightly connected to the circular opening 12 of the manhole pipe 1 through the rubber-based coupler 8 when the sewer main pipe 7 is made of the synthetics or metallic steel.

Due to the water-sealing ridges 82 provided around the inner surface of the rubber-based coupler 8, upon fitting the sewer main pipe 7 into the rubber-based coupler 8, the sewer main pipe 7 elastically pushes the water-sealing ridges 82 outward to exert the rubber-based coupler 8 to diametrically expand, while at the same time, bringing the water-sealing ridges 82 into elastical engagement with an outer surface of the sewer main pipe 7.

This makes it possible to concurrently insure the liquid-tightness between the inner surface of the circular opening 12 and the outer surface of the rubber-based coupler 8 (between the outer surface of the sewer main pipe 7 and the inner surface of the rubber-based coupler 8), thus enabling the user to liquid-tightly connect the sewer main pipe 7 to the circular opening 12 of the manhole pipe 1 through the rubber-based coupler 8.

FIGS. 12-14 show a third embodiment of the invention in which a connection structure (C) is provided so that the sewer main pipe 7 is to be fit into the circular opening 12 with the use of a cylindrical rubber coupler 9 as shown in FIG. 12. With an inner surface of the rubber coupler 9, a water-sealing ridge 91 is provided, while at the same time, an outer flange 93 is formed on a rear end surface of the rubber coupler 9.

The inner surface of the rubber coupler 9 has a stepped portion 92 at a region from the water-sealing ridge 91 to the outer flange 93, while at the same time, the outer surface of the rubber coupler 9 forms an annular recess 94 at a region from the water-sealing ridge 91 to the outer flange 93. Within the annular recess 94, a butylene rubber layer 95 is placed, an outer surface of which is covered by a separable sheet (not shown).

An outer diameter of the rubber coupler 9 is predetermined to be greater than an inner diameter of the circular opening 12. A cylindrical spacer 96, which is made of synthetics, is provided, a rear end of which has an engagement flange 97.

The spacer 96 has a tapered end 96a at a portion opposite to the engagement flange 97 to make the spacer 96 easily fit into the stepped portion 92 of the rubber coupler 9. An outer diameter (M) of the spacer 96 is slightly greater than an inner diameter (N) of the stepped portion 92 of the rubber coupler 9.

In the connection structure (C), a connection work is done in following procedures.

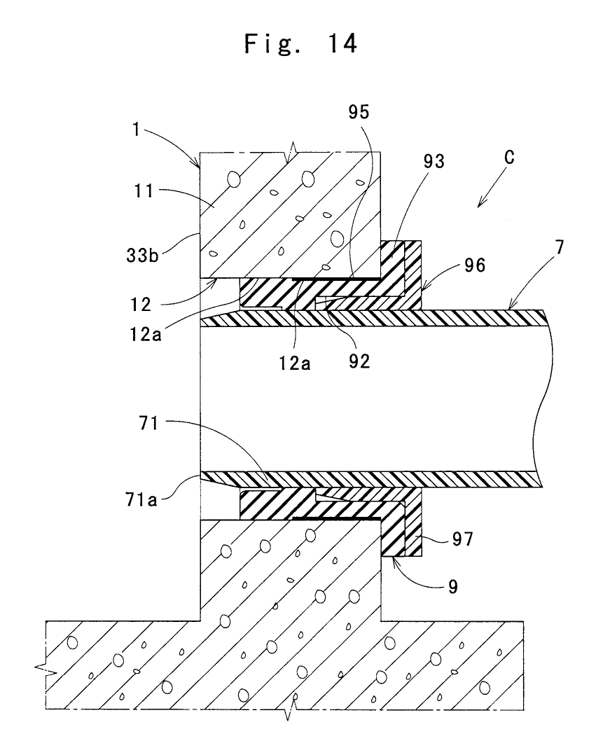

(a) After drilling the circular opening 12 on the side wall 11 of the manhole pipe 1, the rubber coupler 9 is manually fit into the circular opening 12 by working outside the manhole pipe 1 with the separable sheet removed from the butylene rubber layer 95 as shown in FIG. 12.
(b) With a maul (not shown) used outside the manhole pipe 1, the spacer 96 is driven into the stepped portion 92 of the rubber coupler 9 so as to bring the engagement flange 97 into engagement with the outer flange 93 of the rubber coupler 9 as shown in FIG. 13.
(c) The sewer main pipe 7 is press fit through its front portion 71 into the rubber coupler 9 into which the spacer 96 was driven, in such a fashion that a front end surface 71a of the sewer main pipe 7 comes on a level with the inner wall 33b of the manhole pipe 1 (press fitting step).

The connection structure (C) has following advantages.

Upon connecting the sewer main pipe 7 to the manhole pipe 1, the rubber coupler 9 is fit into the inner surface of the circular opening 12 by working outside the manhole pipe 1, while at the same time, driving the spacer 96 into the stepped portion 92 the rubber coupler 9 outside the manhole pipe 1 before press fitting the sewer main pipe 7 into the rubber coupler 9.

This leads to easily connecting the sewer main pipe 7 to the circular opening 12 of the manhole pipe 1 for a short period of time.

Due to the water-sealing ridge 91, upon fitting the sewer main pipe 7 into the rubber coupler 9, the sewer main pipe 7 elastically pushes the water-sealing ridge 91 outward to exert the rubber coupler 9 in such a direction as to diametrically expand.

This makes it possible to concurrently insure the liquid-tightness between the inner surface of the circular opening 12 and the outer surface of the rubber coupler 9 (between the outer surface of the sewer main pipe 7 and the inner surface of the rubber coupler 9), thus enabling the user to liquid-tightly connect the sewer main pipe 7 to the circular opening 12 of the manhole pipe 1 through the rubber coupler 9.

It is to be appreciated that the rubber coupler 9 may be used upon connecting a rain-water pipe to a ditch conduit, instead of connecting the sewer main pipe 7 to the manhole pipe 1.

Although the invention has been described in its preferred embodiments with reference to a mechanical engineer, various changes or alterations may be made in the above apparatus without departing from the scope of the invention, it is intended that all matters contained in the above description or shown in the accompanying drawings shall be interpreted as illustrative and not in a limiting sense.

What is claimed is:

1. A connection structure for a manhole pipe and sewer main pipe in which said sewer main pipe places one end at a circular opening which is provided with a side wall of said manhole pipe so as to connect said sewer main pipe to said manhole pipe through a flexible coupler;
said flexible coupler comprising:
a cylindrical rubber coupler body having a water-sealing ridge around an inner surface of said rubber coupler body, and having a gluey rubber layer around an outer surface of said rubber coupler body, one end of said cylindrical rubber coupler body having an outer flange which is brought into engagement with an outer periphery of said circular opening upon inserting said cylindrical rubber coupler body to said circular opening of said manhole pipe;
a rigid circular pipe press fit inside said cylindrical rubber coupler body by working outside said manhole pipe; and
a rubber coupler cylinder provided to have a diameter increased cylinder portion, a diameter-reduced cylinder portion and a transitionary portion connecting said diameter-increased cylinder portion to said diameter-reduced cylinder portion, said diameter-increased cylinder portion having one end firmly fit to an outer surface of one end of said rigid circular pipe which resides outside said manhole pipe, said diameter-reduced cylinder portion having one end firmly fit to an outer surface of one end of said sewer main pipe which resides outside said manhole pipe.

2. The connection structure for a manhole pipe and sewer main pipe according to claim 1, wherein each of said rigid circular pipe and said sewer main pipe has one open end surface arcuately skived to have a radius of curvature identical to a radius of curvature of an inner wall of said manhole pipe.

3. The connection structure for a manhole pipe and sewer main pipe according to claim 1, wherein said water-sealing ridge has a front end inclined in a direction from an outside to inside of said manhole pipe by an angle ranging from 15 to 60 degrees against the inner surface of said rubber coupler body so as to accept an entrance article upon inserting said entrance article into said rubber coupler body.

4. A connection structure for a manhole pipe and sewer main pipe in which said sewer main pipe is made of synthetics or a metallic steel and said sewer main pipe places one end at a circular opening which pierces through a side wall of said manhole pipe so as to connect said sewer main pipe to said manhole pipe through a rubber-based coupler; and
said rubber-based coupler having a gluey rubber layer circumferentially around an outer surface of said rubber-based coupler, and having a water-sealing ridge around an inner surface of said rubber-based coupler, and further having an outer flange which is brought into engagement with an outer periphery of said manhole pipe upon inserting said rubber-based coupler to said circular opening of said manhole pipe.

5. A connection method for a manhole pipe and sewer main pipe in which a circular opening is provided which pierces through a side wall of said manhole pipe, and a cylindrical rubber coupler body is provided to have a gluey rubber layer circumferentially around an outer surface of said rubber coupler body, and having a water-sealing ridge around an inner surface of said rubber coupler body, and further having an outer flange at one end of said rubber coupler body,
said connection method comprising steps of:
inserting said rubber coupler body to said circular opening which pierces through a side wall of said manhole pipe by working outside said manhole pipe, in order that said outer flange is brought into engagement with an outer periphery of said circular opening;
press fitting a rigid circular pipe into said rubber coupler body by working outside said manhole pipe;
setting a rubber coupler cylinder having a diameter-increased cylinder portion, a diameter-reduced cylinder portion and a transitionary portion connecting said diameter-increased cylinder portion to said diameter-reduced cylinder portion;
firmly fitting one end portion of said diameter-increased cylinder portion to an outer surface of one end of said rigid circular pipe which resides outside said manhole pipe; and
firmly fitting one end portion of said diameter-reduced cylinder portion to an outer surface of one end of said sewer main pipe which resides outside said manhole pipe, upon inserting a front end of said sewer main pipe to said rubber coupler cylinder by working outside said manhole pipe so as to be on a level with an inner wall of said manhole pipe.

6. A connection method for a manhole pipe and sewer main pipe in which a circular opening is provided which pierces through a side wall of said manhole pipe, and a cylindrical rubber-based coupler is provided to have a gluey rubber layer circumferentially around an outer surface of said rubber-based coupler, and having a water-sealing ridge around an inner surface of said rubber-based coupler, and further having an outer flange at one end surface of said rubber-based coupler,
said connection method comprising steps of:
inserting said rubber-based coupler to said circular opening by working outside said manhole pipe, in order that said outer flange is brought into engagement with an outer periphery of said circular opening; and
providing said sewer main pipe out of synthetics or a metallic steel, and press fitting said sewer main pipe into said rubber-based coupler by working outside said manhole pipe, in such a fashion that a front end of said sewer main pipe comes on a level with an inner wall of said manhole pipe.

7. A connection method for a manhole pipe and sewer main pipe in which a circular opening is provided which pierces through a side wall of said manhole pipe, and a cylindrical rubber coupler is provided to have a gluey rubber layer circumferentially around an outer surface of said rubber-based coupler, and having a water-sealing ridge around an inner surface of said rubber-based coupler, and further having an outer flange at a rear end surface of said rubber coupler,
said connection method comprising steps of:
inserting said rubber coupler to said circular opening by working outside said manhole pipe, in such a fashion that said outer flange is brought into engagement with an outer periphery of said circular opening; and
providing a cylindrical spacer, an outer diameter of which is somewhat greater than an inner diameter of said rubber coupler, an engagement flange provided at a rear end surface of said spacer, and driving said spacer into said rubber coupler by working outside said manhole; and
providing said sewer main pipe out of synthetics or a metallic steel, and press fitting said sewer main pipe into said rubber coupler into which said spacer was driven, in such a manner that a front end of said sewer main pipe comes on a level with an inner wall of said manhole pipe.
